(19) United States
(12) Patent Application Publication
(10) Pub. No.: US 2015/0083540 A1
(43) Pub. Date: Mar. 26, 2015

(54) Dog clutch having fluid pressure activated sliding internal gear

(71) Applicant: Jon D. SUMEK, Lemon Grove, CA (US)

(72) Inventor: Jon D. Sumek, La Mesa, CA (US)

(21) Appl. No.: 14/398,230

(22) PCT Filed: May 1, 2013
(86) PCT No.: PCT/US2013/039153

§ 371 Date: Oct. 31, 2014

Related U.S. Application Data
(60) Provisional application No. 61/641,280, filed on May 1, 2012.

(51) Int. Cl. F16D 11/10; F16D 25/08

(52) U.S. Cl. CPC F16D 11/10; F16D 25/08
USPC 192/69.9; 192/85.01

(57) ABSTRACT

A dog clutch having a sliding internally toothed annular power transmitting collar gear (41) which can reciprocatingly slide coaxially to engage and disengage a driving shaft portion (22) from a load shaft (9). The temporarily engaged shaft (22) and collar gear (41) have cooperative teeth (42,36) in which there is a first set of teeth having a given axial length and a second interleaved set having a shorter length. The collar gear is sandwich between a pair of abutting ring-shaped pistons (51,52) within a housing cylinder. Pressurized fluid in either chamber of the cylinder drives the pistons to slide axially. Such a dog clutch mechanism is particularly suited to disengagingly couple a power takeoff (PTO) to an hydraulic pump on a commercial vehicle such as a waste disposal truck.

### PRIOR APPLICATION

This application claims the benefit of U.S. Provisional Application Ser. No. 61/641,280 filed 2012 May 1.

### FIELD OF THE INVENTION

The instant invention relates to mechanical clutch assemblies and more particularly to dog clutch assemblies adapted to disengagingly connect to a motor drive shaft.

### BACKGROUND

Mechanical clutches of various types temporarily couple power from a power source such as the rotating shaft of a motor to a shaft-driven auxiliary load device such as an hydraulic pump. The clutch allows power to be transmitted from the power supply shaft to the load shaft when the clutch is engaged and allows the power supply shaft to rotate essentially unimpeded when the clutch is disengaged.

As with many mechanical components it is often preferred that it be rugged, and inexpensive to manufacture, assemble, operate, maintain and repair. In particular to clutches, it is often preferred that friction on the power drive shaft is minimized when the clutch is disengaged. In particular to power takeoff clutch devices maintaining a compact assembly can help reduce bulk on a commercial vehicle.

Another type of clutch is a geared clutch also known as a dog clutch which uses a sliding gear to connect and disconnect the powered, drive shaft to the load shaft. The dog clutch disclosed in Robinson, U.S. Pat. No. 7,832,538 incorporated herein by reference, (hereinafter “Robinson”) is used to disengagingly drive an hydraulic pump in a commercial vehicle using a power takeoff (PTO) from the vehicle's main motor.

The Robinson device presents some problems in practice. First, the sliding shift fork can introduce off-axis forces which can lead to greater wear and jamming of the clutch or sliding gear. Second, the sliding gear contacts the fork directly leading to greater wear. Third, the use of the lock teeth can wear against the spline ends of the drive and load shafts.

The instant invention results from efforts to improve dog clutches.

### SUMMARY

The primary and secondary objects of the invention are to provide an improved dog clutch. These and other objects are achieved in a first aspect by providing a roller bearing supported internally toothed annular power transmitting collar gear which can reciprocatingly slide coaxially to engage and disengage a driving shaft from a load shaft. In some embodiments the temporarily engaged shaft and collar gear have cooperative teeth in which there is a first set of teeth having a given axial length and a second interleaved set having a shorter length.

In some embodiments there is provided that in a dog clutch assembly, comprising: a first shaft having an interface end portion with teeth on its outer diameter, the first shaft having a longitudinal axis; a second shaft having an interface end portion with teeth on its outer diameter, the second shaft having a longitudinal axis that is collinear with the longitudinal axis of the first shaft; a gap between the first shaft and the second shaft in a direction along the longitudinal axes of the shafts; an annular clutch having teeth along its inner diameter that engage the teeth of the first shaft and teeth of the second shaft when the clutch is in an engaged position, and that engage only the teeth of the first shaft or the teeth of the second shaft when it is in a disengaged position, wherein the engaged position and the disengaged position are linearly displaced from one another along the longitudinal axis of the shafts; an improvement wherein said annular clutch comprises: a first subset of said annular clutch teeth having a first length; and; a second subset of said annular clutch teeth having a second length shorter than said first set.

In some embodiments the improvement further comprises: a driving actuator that drives the clutch between the engaged position and the disengaged position; wherein said driving actuator comprises: a first annular piston in direct contact with a second annular piston slidingly connected to said clutch.

In some embodiments said driving actuator further comprises: a first portion of said first piston residing in a first pressure-based chamber; a second portion of said second piston residing in a second pressure-based chamber; wherein the presence of fluid under sufficient pressure in one of said portions actuates the clutch.

In some embodiments said first shaft is rotatively supported by said second shaft by a pilot bearing.

In some embodiments the improvement further comprises a wave spring resisting axial movement of said pilot bearing.

In some embodiments the improvement further comprises: said first and second shafts comprise ferrous metal; a plural number of permanent magnets balancingly fitted to at least one of said shafts in locations exposed to wear fragments generated by the engaging and disengaging teeth during operation of said annular clutch assembly.

In some embodiments there is provided that in a dog clutch assembly, comprising: a first shaft having an interface end portion with teeth on its outer diameter, the first shaft having a longitudinal axis; a second shaft having an interface end portion with teeth on its outer diameter, the second shaft having a longitudinal axis that is collinear with the longitudinal axis of the first shaft; a gap between the first shaft and the second shaft in a direction along the longitudinal axes of the shafts; an annular clutch having teeth along its inner diameter that engage the teeth of the first shaft and teeth of the second shaft when the clutch is in an engaged position, and that engage only the teeth of the first shaft or the teeth of the second shaft when it is in a disengaged position, wherein the engaged position and the disengaged position are linearly displaced from one another along the longitudinal axis of the shafts; an improvement which comprises: a driving actuator that drives the clutch between the engaged position and the disengaged position; wherein said driving actuator comprises: a first annular piston in direct contact with a second annular piston is rotatively connected to said clutch.

In some embodiments the driving actuator further comprises: a first portion of said first piston residing in a first pressure-based chamber; a second portion of said second piston residing in a second pressure-based chamber; wherein the presence of fluid under sufficient pressure in one of said portions actuates the clutch.

In some embodiments the presence of fluid under sufficient pressure in said first portion drives said clutch toward said engaged position and wherein the presence of fluid under sufficient pressure in said second portion drives said clutch toward said disengaged position.

In some embodiments the improvement further comprises a stop surface of said second piston contacts a stop surface in said second chamber when said clutch is in said engaged position; and wherein a stop surface of said first piston contacts a stop surface in said first chamber when said clutch is in said dis-engaged position.

In some embodiments said first piston rotatively connects to said clutch through a first clutch bearing; and wherein said second piston rotatively connects to said clutch through a second clutch bearing; and wherein said direct contact limits axial loads on said clutch bearings.

In some embodiments the improvement further comprises: a first subset of said annular clutch teeth having a first length; and; a second subset of said annular clutch teeth having a second length shorter than said first set.

In some embodiments said first shaft is rotatively supported by said second shaft by a pilot bearing.

In some embodiments the improvement further comprises a wave spring resisting axial movement of said pilot bearing.

In some embodiments the improvement further comprises: said first and second shafts comprise ferrous metal; a plural number of permanent magnets balancingly fitted to at least one of said shafts in locations exposed to wear fragments generated by the engaging and disengaging teeth during operation of said annular clutch assembly.

The content of the original claims is incorporated herein by reference as summarizing features in one or more exemplary embodiments.

### BRIEF DESCRIPTION OF THE DRAWINGS

FIG. 1 is a diagrammatical perspective illustration of an assembled dog clutch assembly according to an exemplary embodiment of the invention.

FIG. 2 is a diagrammatical side plan view illustration of the assembled dog clutch assembly of FIG. 1.

FIG. 3 is a diagrammatical front plan view illustration of the assembled dog clutch assembly of FIG. 1.

FIG. 4 is a diagrammatical perspective exploded illustration of a dog clutch assembly of FIG. 1.

FIG. 5 is a diagrammatical perspective exploded illustration of some of the major components of a dog clutch assembly of FIG. 1.

FIG. 6 is a diagrammatic cross-sectional side view of the dog clutch assembly of FIG. 1 taken along line 6-6 of FIG. 3 in the engaged position.

FIG. 7 is a diagrammatic cross-sectional side view of the dog clutch assembly of FIG. 1 taken along line 6-6 of FIG. 3 in the disengaged position.

FIG. 8 is a diagrammatic cross-sectional side view of the temporarily engaged shaft and collar gear having bifurcated teeth lengths in the act of being engaged.

FIG. 9 is a diagrammatic cross-sectional side view of the temporarily engaged shaft and collar gear in the power transmitting condition.

FIG. 10 is a diagrammatic cross-sectional side view of the temporarily engaged shaft and collar gear in the power transmitting condition using both sets of bifurcated length teeth.

FIG. 11 is a diagrammatical perspective exploded illustration of a dog clutch assembly according to an alternate exemplary embodiment of the invention.

FIG. 12 is a diagrammatical perspective exploded illustration of the drive shaft portion of the assembly of FIG. 11.

FIG. 13 is a diagrammatical perspective exploded illustration of the load shaft portion of the assembly of FIG. 11.

FIG. 14 is a diagrammatical perspective exploded illustration of the rearward piston and inter-piston guide pins of the assembly of FIG. 11.

### DESCRIPTION OF THE EXEMPLARY EMBODIMENTS

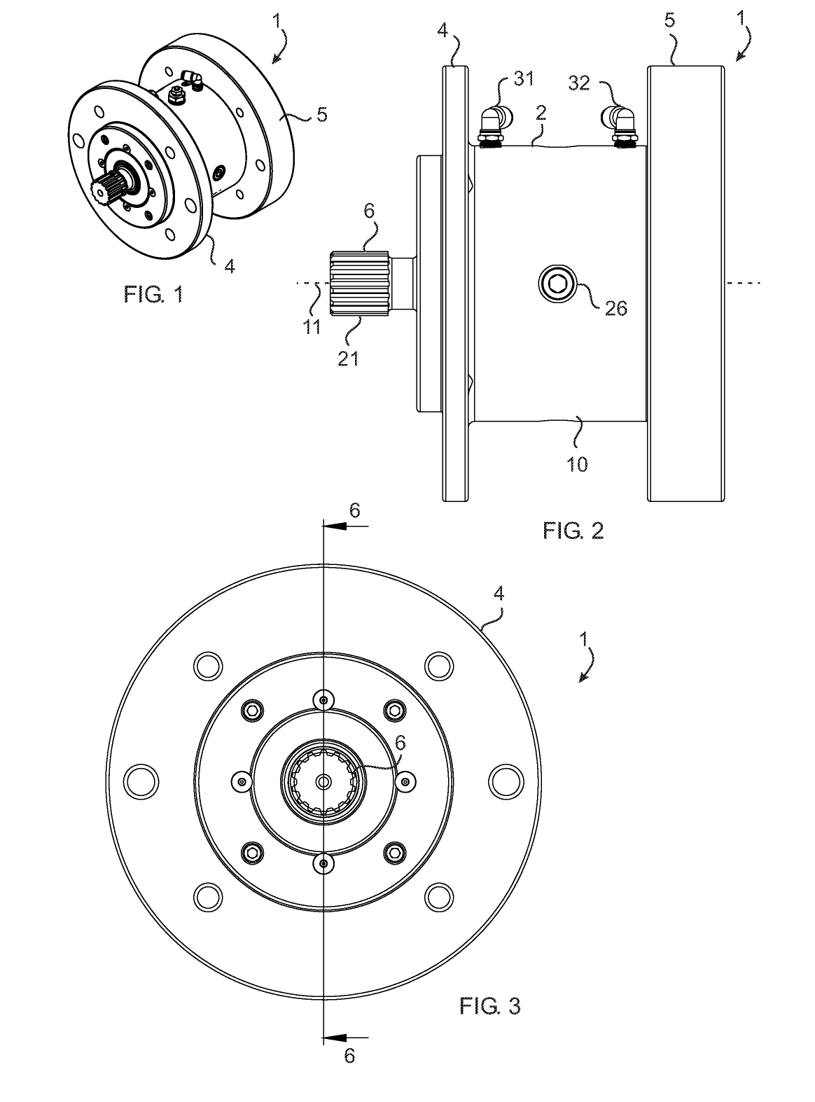

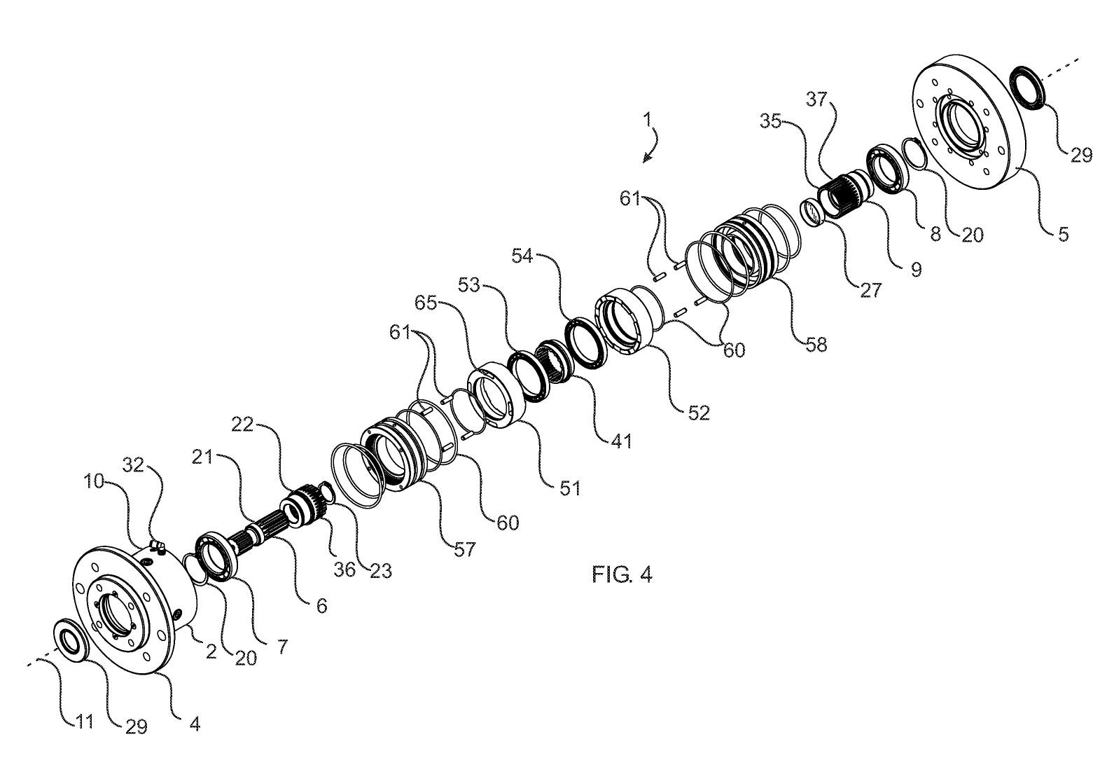

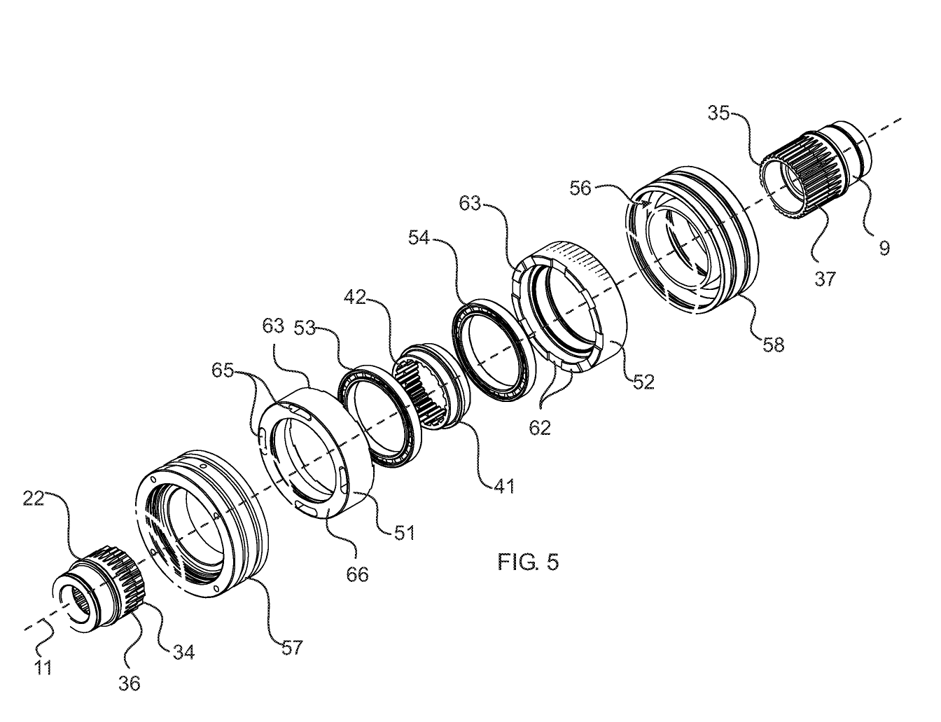

Referring now to the drawing, there is illustrated in FIGS. 1-7 a dog clutch assembly 1 according to an exemplary embodiment of the invention.

The assembly 1 includes a housing 2 having an internal cavity 3 for containing most of the other components of the clutch assembly. The housing has a front flange 4 adapted to secure the housing to a substantially stationary structure associated with a power supplying shaft (not shown) such as a power takeoff (PTO) and a back flange 5 adapted to secure the housing to a substantially stationary structure associated with a shaft driven load unit such as an hydraulic pump. The front flange surrounds the clutch assembly's rotatively supported drive shaft 6 which connects to the power supplying shaft. A bearing 7 rotatively supports the drive shaft with respect to the front flange. Another bearing 8 rotatively supports the load shaft 9 with respect to the back flange 5. The back flange surrounds the clutch assembly's rotatively supported load shaft which connects to the shaft of the load unit. When assembled, the flanges are separated by a substantially cylindrical housing side wall 10. The drive shaft and load shaft are located coaxially along a common rotation axis 11.

Axial movement of the two shafts with respect to the housing is restricted by a pair of snap rings 20. The temporarily engaged drive shaft can be formed by an outwardly extending shaft 21 coupled with a continuously engaged ring gear 22. The ring gear and extending shaft can be engaged by cooperative splines as shown or other keyed mechanisms which angularly couple the extending shaft to the ring gear. The ring gear thus becomes the element of the assembly which is temporarily engaged by the collar gear. Thus, the combined extending shaft and ring gear can be referred to collectively as the temporarily engaged shaft, or in this embodiment, the drive shaft. A snap ring 23 restricts relative axial movement between the ring gear and extending shaft.

Threaded lubrication holes 25 are sealed by removable threaded plugs 26. A central friction fitting plug 27 seals the central lumen 28 of the load shaft. Seals 29 seal the junction between the shafts and the housing. A pair of drive fluid intake ports 31,32 penetrate through the housing wall to supply air or other fluid for activating the clutch.

The facing ends 34,35 of the shafts internal to the assembly housing are coaxial and splined to have outwardly projecting teeth 36,37. The shafts are axially spaced apart by an axial distance to form a gap 40 therebetween.

Power is transmitted from the drive shaft to the load shaft by a coaxial internally toothed collar gear 41 also known as a slider gear, also known as an annular clutch, which can reciprocatingly slide coaxially to engage and disengage a driving shaft from a load shaft. The collar gear can have inwardly projecting teeth 42 shaped dimensioned and oriented for engaging the two shafts. The collar gear engages both shafts during power transmitting operation when the collar gear is in the engaged position. Power is disconnected between the shafts when the collar gear slides axially off the drive shaft but remains on the load shaft when the clutch is in the disengaged position. Although in this embodiment the drive shaft is the temporarily engaged shaft and the load shaft is the continuously, or non-temporarily engaged shaft, the two could be switched so that the load shaft is temporarily engaged and the drive shaft is continuously engaged.

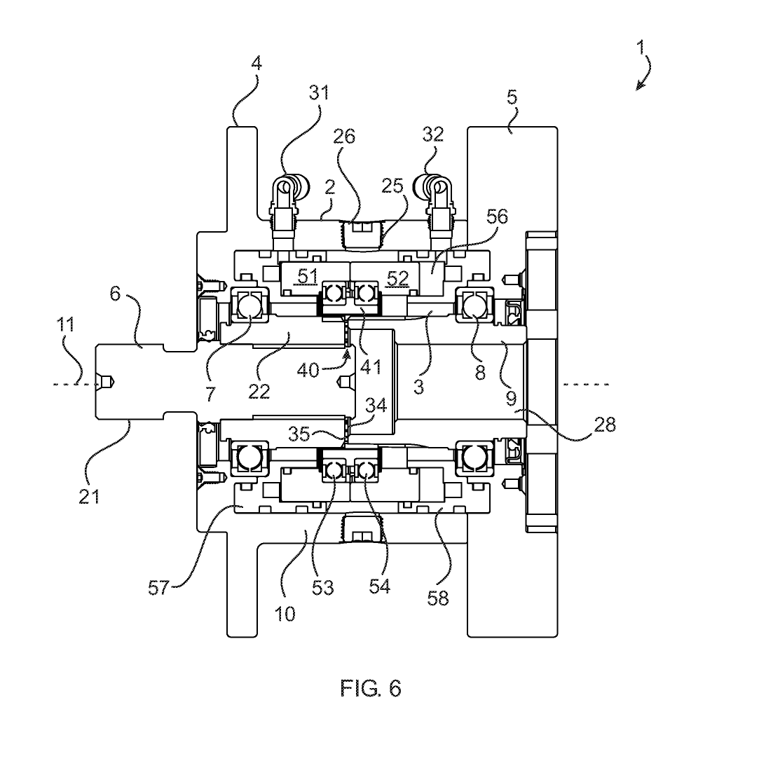

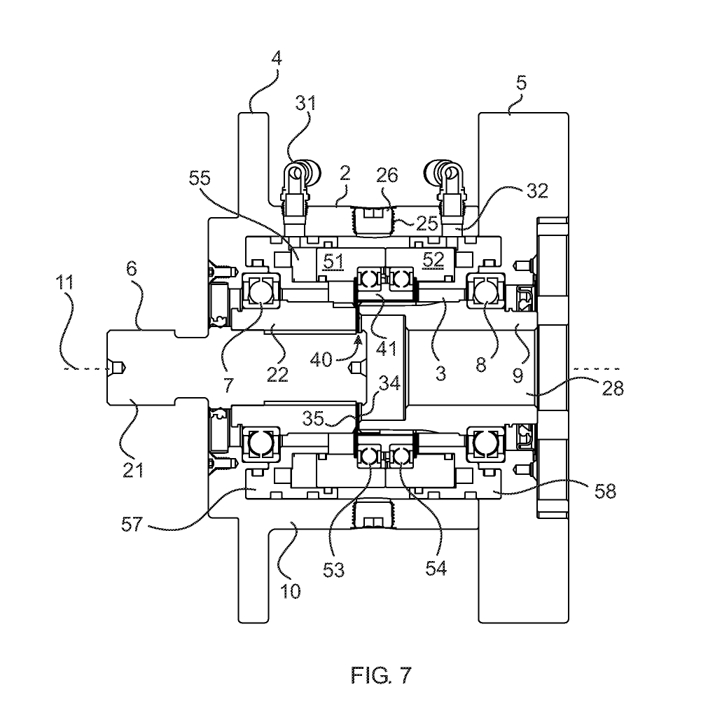

As shown primarily in FIGS. 6-7, the axial movement of the collar gear between the engaged and disengaged position is controlled by a pneumatically driven system acting on a pair of coaxial annular pistons 51,52 rotatively coupled to the collar gear by a pair of coaxial rolling-element bearings 53,54. The pistons move axially within a pair of coaxial annular chambers 55,56 formed by a pair of coaxial annular piston housings 57,58 located astride the axial range of movement of the pistons. By providing roller-element bearings, there is less wear on the collar gear and the actuation elements including the pistons. Sealer rings 60 form substantially hermetic seals between the pistons and their respective piston housings and between the piston housings and the assembly housing. Guide pins 61 restrict angular movement of the pistons with respect to the housings while allowing axial movement. Angular and cooperatively engaging crenelations 62 are formed on the abutting surfaces 63 of the pistons so that their mutual angular orientation is assured.

As shown in FIG. 6, in order for the assembly to be in the engaged position, air is injected into the port 32 in fluid communication with one of the chambers 56 formed between the piston 52 and the piston housing 58, which forces the piston to move axially out of the chamber, driving the collar gear 41 over the end of the drive shaft, and consequently driving the other piston 51 into its associated piston housing 57 and engaging the other chamber 55.

As shown in FIG. 7, in order for the assembly to be in the disengaged position, air is injected into the port 31 in fluid communication with the other chamber 55 formed between the piston 51 axially nearer to the drive shaft and its piston housing 57, which forces that piston to move axially out of its chamber, driving the collar gear 41 off the end of the drive shaft and completely onto the load shaft, and consequently driving the piston 52 nearest the load shaft into its associated piston housing 58 and engaging its chamber 56.

A number of arcuately oval depressions 65 can be formed into the faces 66 of the pistons facing their respective chambers so that guide pins can engage them and restrict angular rotation of the pistons with respect to their piston housings and so that air can initially more easily begin to flow into the chamber when the piston is fully engaged in its respective piston housing. The arcuate oval shape can be used to provide for slight angular play to facilitate assembly.

Although pneumatic actuation is used in the exemplary embodiment, the assembly can be adapted to use other driving fluids such as hydraulic fluid. In addition, the assembly can be adapted so that movement of the slider gear can be accomplished using other mechanical or electro-mechanical means known in the art.

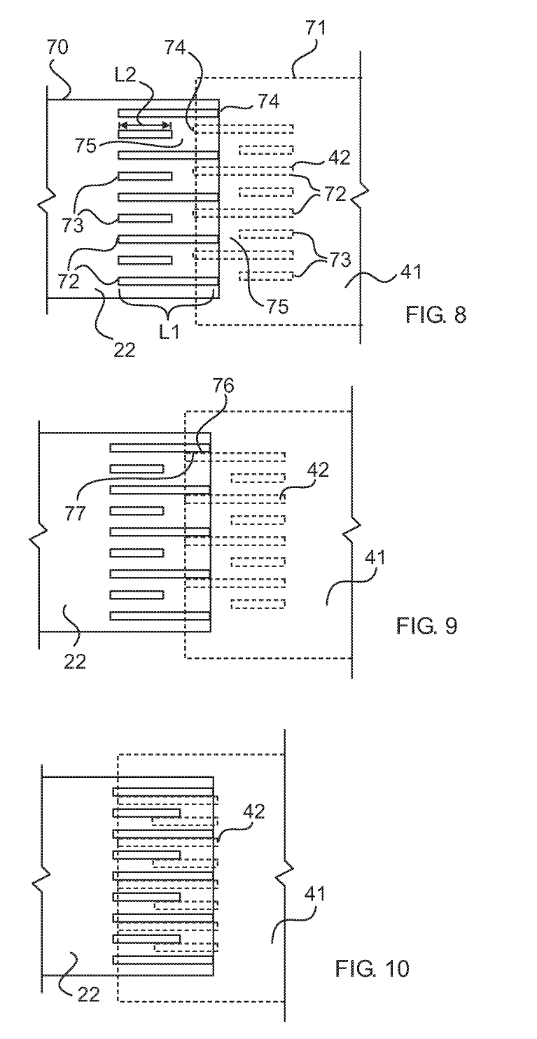

As shown in FIG. 8 the temporarily engaged shaft 70 and collar gear 71 are formed to have cooperative sets of teeth 72,73 having bifurcated axial lengths. Specifically, a first set of teeth 72 are formed having a first longer axial length L1. A second set of teeth 73 shorter axial length L2 are interspersed between the longer teeth so that every other tooth is a member of one of the sets.

As shown in FIG. 8, during an engagement action the slider gear slides over the temporarily-engaged gear so that the ends 74 of the longer teeth pass into the spacing 75 formed between the longer teeth of the gear and shaft. Relative angular motion between the slider gear and the temporarily-engaged gear typically occurs during the engagement action until the faces 76,77 of the teeth bear against one another as shown in FIG. 9 so that torque and be transmitted. The collar gear can continue to slide axially in alignment until the collar gear has fully engaged the temporarily-engaged gear to be in the engaged position.

The bifurcated length teeth provide several advantages over a slider gear and temporarily-engaged gear having a single set of enmeshing teeth.

First, during an engagement action there is a lesser chance that the axial travel of the slider gear is temporarily blocked from engagement due to a non-synchronization with the temporarily-engaged gear. In other words, if the relative angular orientation of the two gears is such that the leading ends of the teeth of the slider gear contact the leading ends of the teeth on the temporarily-engaged gear, there may be a delay in full engagement or increased wear on the teeth ends. By creating more unblocked angular space for the gears ends to mesh the chances of the teeth being in a blocking orientation during an engagement action are reduced

Second, since the opposite end of the slider gear has essentially a standard spline it can engage the always-engaged gear using both sets of teeth to restrict that interface from relative angular motion. In other words, the greater spaced apart longer teeth are fully capable of engaging every other tooth of the spline of the continuously engaged gear.

The shorter length teeth are easily manufacture by first creating a single set of longer teeth. Then every other one of the longer teeth is machined to remove material and make the selected every-other tooth shorter.

For many applications such as the power takeoff disconnect for hydraulic pumps on commercial vehicles, where backlash between the slider gear and temporarily-engaged gear is not a problem, only the longer axial length teeth set between the two gears need be engaged. However, in other applications where backlash is to be avoided, the axial length of the shorter set of teeth can be made longer so that in a full engagement position as shown in FIG. 10 both sets of teeth are engaged between the slider gear and the temporarily-engaged gear, restricting relative angular motion between the gears and essentially eliminating any offending backlash.

It has been found that the bifuracted axial length teeth, in which there is a first set of teeth having a given axial length and a second interleaved set having a shorter length, also provide improved engagement action by better lubrication because the presence of the shorter teeth within the spacing of the longer teeth helps carry a miniscus of lubrication fluid nearer to the ends of the longer teeth. In other words, through surface tension forces it has been found that the presence of the shorter teeth help provide more lubrication to the ends of the longer teeth than would be expected if only double-spaced, longer teeth were used.

Because the collar gear is sandwiched between a pair of abutting ring-shaped pistons the pistons protect the collar ring and bearings against contacts and greater axial loads during the engage and disengage actions especially when the piston reach the end of their ranges of motion. In other words, when a piston is forced into position it can strike against the wall of its housing accommodating the load of the axial motion rather than the collar gear or the bearings. The combination of the piston and housing creates a stop surface to prevent over-travel of the sliding gear. This reduces the stresses on the collar gear and bearings allowing for greater life of the part and potentially reduced bulkiness of the parts.

Such a dog clutch mechanism is particularly suited to disengagingly couple a power takeoff (PTO) to an hydraulic pump on a commercial vehicle such as a waste disposal truck.

In this specification the piston in contact with the pressurized fluid can be known as the pressurized piston and the other piston which is retracting into its “housing” can be known as the non-pressurized piston.

By providing the separated pair of roller bearings between the sliding collar gear and the pistons additional bearing support is provided continuously to the load shaft and intermittently to the drive shaft. Both shafts are engaged during power transmission in the engaged position. In this way the size of the assembly can be further reduced.

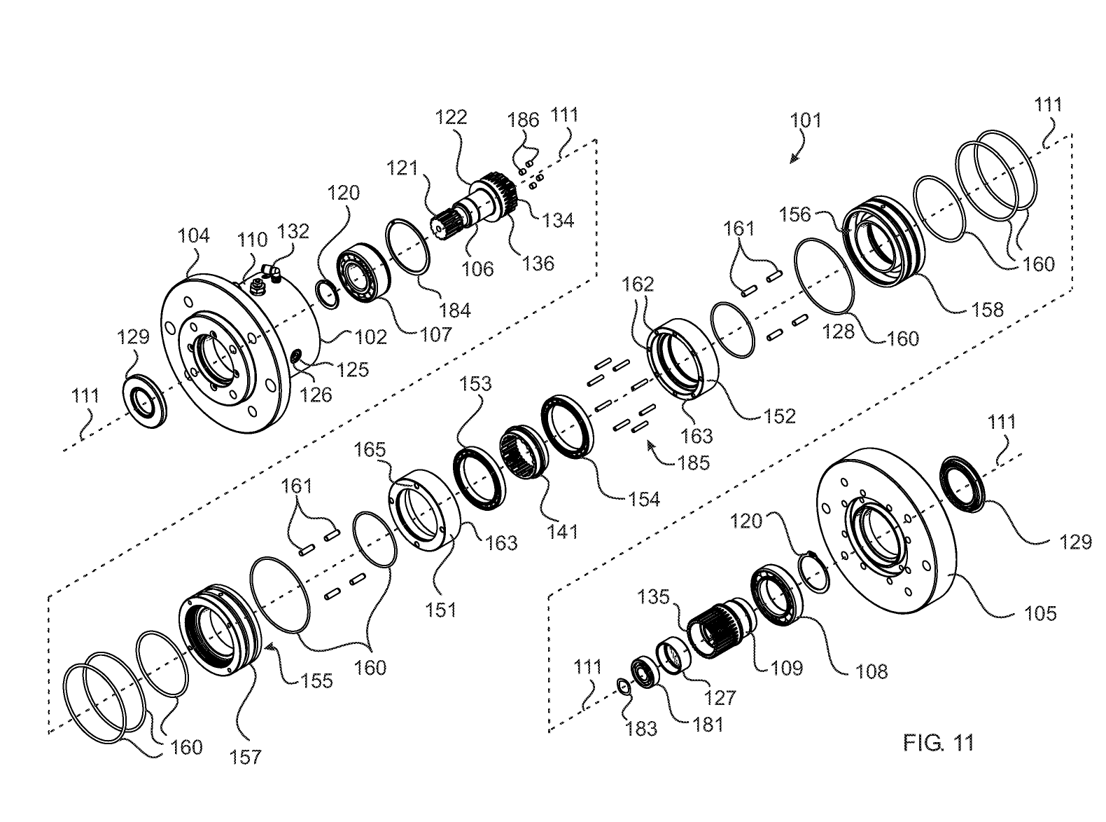

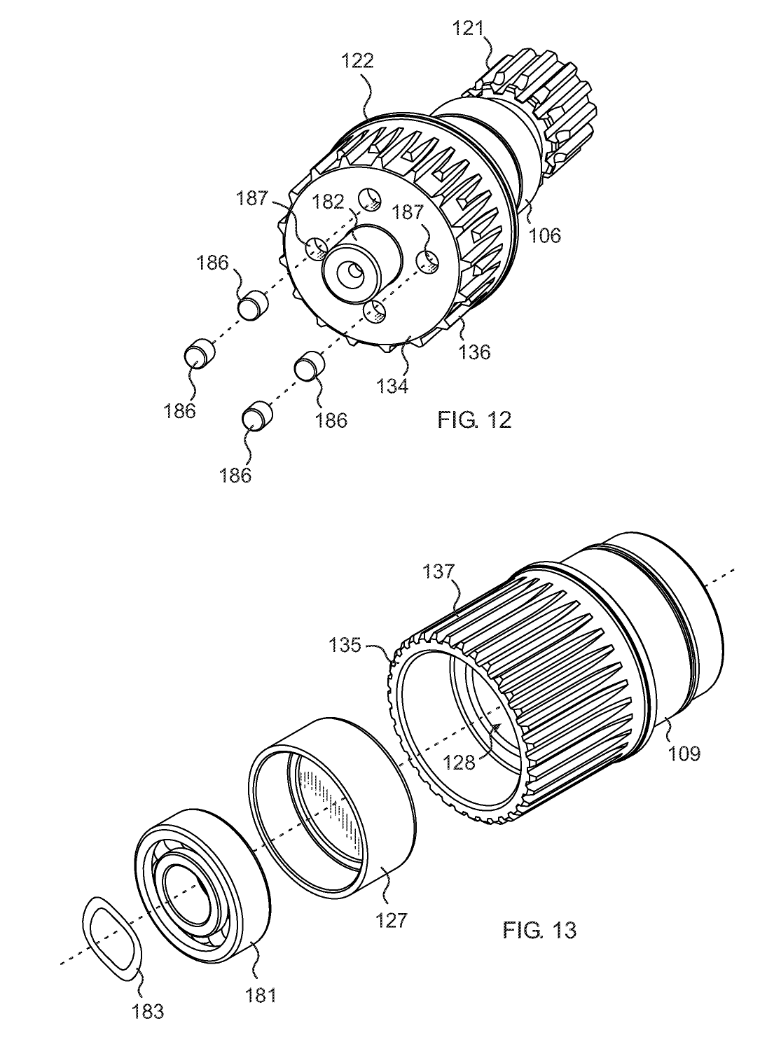

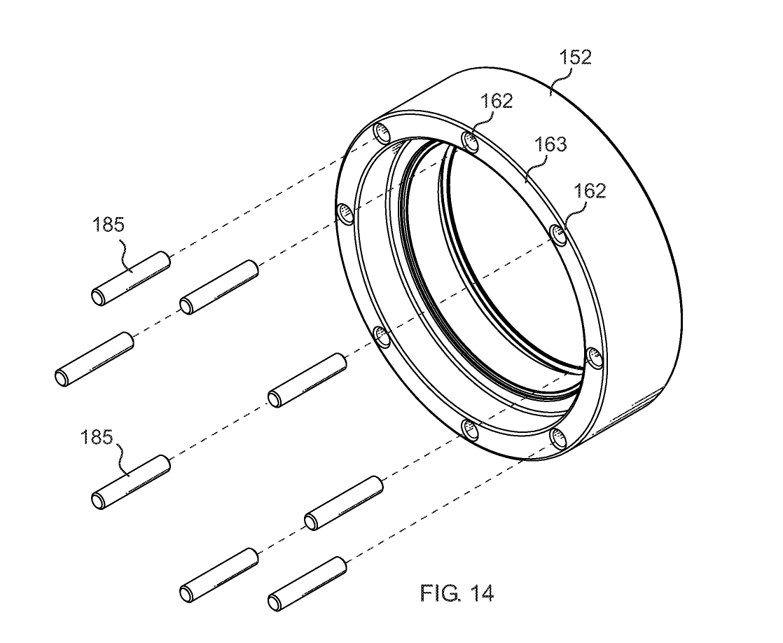

Referring now to FIGS. 11-14 there is shown a dog clutch assembly 101 according to an alternate exemplary embodiment of the invention. This embodiment operates similarly to the embodiment of FIG. 1 except where indicated below.

The assembly 101 includes a housing 102 having a front flange 104, and a back flange 105. A bearing 107 rotatively supports a drive shaft 106 with respect to the front flange and is secured to the housing by a snap ring 184. Another bearing 108 rotatively supports the load shaft 109 with respect to the back flange 105. When assembled the flanges are separated by a substantially cylindrical housing side wall 110. The drive shaft and load shaft are located coaxially along a common rotation axis 111.

Axial movement of the two shafts with respect to the housing is restricted by a pair of snap rings 120. The temporarily engaged drive shaft can be formed to have an outwardly frontwardly extending shaft 121 portion and a rearward ring gear 122 portion. The ring gear and extending shaft can be two continuously engaged components as in the previous embodiment or by a unitary machined component. The ring gear portion becomes the element of the assembly which is temporarily engaged by the collar gear described below. Thus, the combined extending shaft and ring gear can be referred to collectively as the temporarily engaged shaft, or in this embodiment, the drive shaft.

Threaded lubrication holes 125 are sealed by removable threaded plugs 126. A central friction fitting plug 127 seals the central lumen 28 of the load shaft. Seals 129 seal the junction between the shafts and the housing. A pair of drive fluid intake ports 132 penetrate through the housing wall to supply air or other fluid for activating the clutch.

The facing ends 134,135 of the shafts internal to the assembly housing are coaxial and splined to have outwardly projecting teeth 136,137. A pilot bearing 181 mounts on the front end of the load shaft 109 within the plug 127 and rotatively supports a corresponding pilot axle 182 extending rearwardly for the rear end of the drive shaft 106. A wave spring 183 prevents forward axial migration of the bearing out of its seated position in the load shaft. A plural number of permanent magnets 186 can be fitted into a corresponding number of uniformly angularly spaced apart recesses 187 in the rearwardly facing end 134 of the drive shaft so that exposed surfaces of the magnets are located and oriented to capture any ferrous metal wear fragments generated by the engaging and disengaging of the gears. This reduces wear on part which would have been subjected to the fragments. The number and spacing of the magnets is selected to maintain rotational balance of the shaft to which they are fitted.

As with the previous embodiment, power is transmitted from the drive shaft 106 to the load shaft 109 by a coaxial internally toothed collar gear 141 also known as a slider gear, also known as an annular clutch, which can reciprocatingly slide coaxially to engage and disengage a driving shaft from a load shaft. The axial movement of the collar gear is controlled by a pneumatically driven system acting on a pair of coaxial annular pistons 151,152 rotatively coupled to the collar gear by a pair of coaxial rolling-element bearings 153,154. The pistons move axially within a pair of coaxial annular chambers 155 (hidden),156 formed by a pair of coaxial annular piston housings 157,158 located astride the axial range of movement of the pistons. Sealer rings 160 form substantially hermetic seals between the pistons and their respective piston housings and between the piston housings and the assembly housing.

Guide pins 161 restrict angular movement of the pistons with respect to the housings while allowing axial movement. Eight piston-to-piston guide pins 185 engage corresponding holes 162 formed on the facing surfaces 163 of the pistons so that their mutual angular orientation is assured.

While the preferred embodiment of the invention has been described, modifications can be made and other embodiments may be devised without departing from the spirit of the invention and the scope of the appended claims.

What is claimed is:

1. In a dog clutch assembly, comprising:
a first shaft having an interface end portion with teeth on its outer diameter, the first shaft having a longitudinal axis;
a second shaft having an interface end portion with teeth on its outer diameter, the second shaft having a longitudinal axis that is collinear with the longitudinal axis of the first shaft;
a gap between the first shaft and the second shaft in a direction along the longitudinal axes of the shafts;
an annular clutch having teeth along its inner diameter that engage the teeth of the first shaft and teeth of the second shaft when the clutch is in an engaged position, and that engage only the teeth of the first shaft or the teeth of the second shaft when it is in a disengaged position, wherein the engaged position and the disengaged position are linearly displaced from one another along the longitudinal axis of the shafts;
an improvement wherein said annular clutch comprises:
a first subset of said annular clutch teeth having a first length; and;
a second subset of said annular clutch teeth having a second length shorter than said first set.

2. The improvement of claim 1, which further comprises:
a driving actuator that drives the clutch between the engaged position and the disengaged position;
wherein said driving actuator comprises:
a first annular piston in direct contact with a second annular piston slidingly connected to said clutch.

3. The improvement of claim 2, wherein said driving actuator further comprises:
a first portion of said first piston residing in a first pressure-based chamber;
a second portion of said second piston residing in a second pressure-based chamber;
wherein the presence of fluid under sufficient pressure in one of said portions actuates the clutch.

4. The improvement of claim 1, wherein said first shaft is rotatively supported by said second shaft by a pilot bearing.

5. The improvement of claim 4, which further comprises a wave spring resisting axial movement of said pilot bearing.

6. The improvement of claim 1, which further comprises:
said first and second shafts comprise ferrous metal;
a plural number of permanent magnets balancingly fitted to at least one of said shafts in locations exposed to wear fragments generated by the engaging and disengaging teeth during operation of said annular clutch assembly.

7. In a dog clutch assembly, comprising:
a first shaft having an interface end portion with teeth on its outer diameter, the first shaft having a longitudinal axis;
a second shaft having an interface end portion with teeth on its outer diameter, the second shaft having a longitudinal axis that is collinear with the longitudinal axis of the first shaft;
a gap between the first shaft and the second shaft in a direction along the longitudinal axes of the shafts;
an annular clutch having teeth along its inner diameter that engage the teeth of the first shaft and teeth of the second shaft when the clutch is in an engaged position, and that engage only the teeth of the first shaft or the teeth of the second shaft when it is in a disengaged position, wherein the engaged position and the disengaged position are linearly displaced from one another along the longitudinal axis of the shafts;
an improvement which comprises:
a driving actuator that drives the clutch between the engaged position and the disengaged position;
wherein said driving actuator comprises:
a first annular piston in direct contact with a second annular piston is rotatively connected to said clutch.

8. The improvement of claim 7, wherein said driving actuator further comprises:
a first portion of said first piston residing in a first pressure-based chamber;
a second portion of said second piston residing in a second pressure-based chamber;
wherein the presence of fluid under sufficient pressure in one of said portions actuates the clutch.

9. The improvement of claim 8, wherein the presence of fluid under sufficient pressure in said first portion drives said clutch toward said engaged position and wherein the presence of fluid under sufficient pressure in said second portion drives said clutch toward said disengaged position.

10. The improvement of claim 9, wherein a stop surface of said second piston contacts a stop surface in said second chamber when said clutch is in said engaged position; and wherein a stop surface of said first piston contacts a stop surface in said first chamber when said clutch is in said dis-engaged position.

11. The improvement of claim 7, wherein said first piston rotatively connects to said clutch through a first clutch bearing; and wherein said second piston rotatively connects to said clutch through a second clutch bearing; and wherein said direct contact limits axial loads on said clutch bearings.

12. The improvement of claim 7, wherein said improvement further comprises:
a first subset of said annular clutch teeth having a first length; and;
a second subset of said annular clutch teeth having a second length shorter than said first set.

13. The improvement of claim 7, wherein said first shaft is rotatively supported by said second shaft by a pilot bearing.

14. The improvement of claim 13, which further comprises a wave spring resisting axial movement of said pilot bearing.

15. The improvement of claim 7, which further comprises:
said first and second shafts comprise ferrous metal;
a plural number of permanent magnets balancingly fitted to at least one of said shafts in locations exposed to wear fragments generated by the engaging and disengaging teeth during operation of said annular clutch assembly.
